(19) United States
(12) Patent Application Publication
(10) Pub. No.: US 2015/0002554 A1
(43) Pub. Date: Jan. 1, 2015

(54) POWER SAVING TECHNIQUES FOR DISPLAYS WITH PIXEL-ADDRESSABLE INTENSITY

(71) Applicant: DSP Group LTD., Herzeliya (IL)

(72) Inventors: Haim Kupershmidt, Or Yehuda (IL); Graham Kenneth Smith, El Dorado Hills, CA (US)

(73) Assignee: DSP Group LTD., Herzeliya (IL)

(21) Appl. No.: 14/284,620

(22) Filed: May 22, 2014

Related U.S. Application Data
(60) Provisional application No. 61/839,396, filed on Jun. 26, 2013.
(60) Provisional application No. 61/847,588, filed on Jul. 18, 2013.

(51) Int. Cl. G09G 3/32

(52) U.S. Cl. CPC G09G 3/3208; G09G 2320/0686; G09G 2330/023
USPC 345/690; 345/77

(57) ABSTRACT

A method for power management of a self-luminous display having a pixel addressable intensity, the method is executed by a device that comprises the self-luminous display. The method may include determining a selected area and a non-selected area of the self-luminous display; and reducing power consumption associated with the non-selected area.

### RELATED APPLICATIONS

This application claims priority from U.S. provisional patent Ser. No. 61/839,396 filing date Jun. 26, 2013 and from U.S. provisional patent Ser. No. 61/847,588 filing date Jul. 18, 2013, both being incorporated herein by reference.

### BACKGROUND OF THE INVENTION

Displays are available where the individual pixels can be selected and their intensity varied. An example of such a display is the Organic Light-Emitting Diode (OLED) display which is made by placing a series of organic thin films between two conductors. A bright light is emitted when an electrical current is applied and such displays do not require backlighting. The power consumption of such a display is variable according to the number and brightness of the illuminated pixels. With OLED technology and other display technologies it is possible to select individual pixels for illumination and this feature can be used to save power. For any battery driven mobile device, power consumption and battery life is an important, critical feature. In such devices, which include smartphones, computer tablets, laptop computers, for examples, the display is a major power drain on the device. The displays in such devices have become more high definition, bigger, and the applications and uses of them have become more display oriented (e.g. web browsing, multimedia, games, etc.), the significance of power drain by the display has grown, and is expected to grow in the future. In addition, uses of these devices, in particular cellular phones and tablets, in an outdoor, sunny environment have meant that higher illumination of the display is often necessary. All of which result in a significant increase in power consumption.

Some power saving techniques are illustrated in the following patents and patent application: U.S. Pat. No. 8,373,648, U.S. Pat. No. 8,407,502, U.S. Pat. No. 6,734,845, U.S. Pat. No. 7,614,011 and US patent application 20130027323.

It is advantageous therefore, to use a power save scheme that can control the illumination and pixels in a selected area of the display while reducing the illumination and number of pixels being used in other areas of the display, and to do so such that the user's perception of the device and application is not adversely affected, especially when it is accompanied by a significant improvement in battery life.

### SUMMARY OF THE INVENTION

According to an embodiment of the invention there may be provided a method for power management of a self-luminous display having a pixel addressable intensity, the method may be executed by a device that may include the self-luminous display and may include determining a selected area and a non-selected area of the self-luminous display; and reducing power consumption associated with the non-selected area.

The self-luminous display may be fed by content generated by an application; wherein the determining of the selected area may be responsive to a type of the application.

The application may be selected out of a text processing application and a video application.

The applications of different types differ from each other by an expected variation in a direction of a user gaze.

The reducing of the power may be responsive to environmental conditions.

The reducing of the power may be responsive to a state of a power source that feeds the self-luminous display.

The determining of the selected area may be responsive to a position of a user in relation to the self-luminous display.

The method may include sensing a distance between the user and the self-luminous display by a specific absorption rate proximity detector.

The reducing of the power consumption may include at least one out of reducing illumination of at least some pixels of the non-selected area and reducing pixel density of the of the non-selected area.

The method may include defining at least one additional area of the self-luminous display; and associating different power consumption levels with each one of the selected area, the non-selected area and each additional area.

The method may include displaying to a user multiple power saving options; receiving from the user a selected power saving option indication and reducing the power consumption associated with the non-selected area in response to the selected power saving option.

The determining of selected area and of non-selected area of the self-luminous display may be responsive to a location point of contact between the self-luminous display and at least one of a user and a user held object.

The method may include defining at least one additional area of the self-luminous display; and associating different power consumption levels with each one of the selected area, the non-selected area and each additional area.

The self-luminous display may be a three-dimensional display and the determining of the selected area may be responsive to a location, within a three dimensional display space generated by the self-luminous display, of either one of an organ of a user and a user held object that does not contact the self-luminous display.

According to an embodiment of the invention there may be provided a non-transitory computer readable medium that may store instructions that once executed by a computer may cause the computer to determine a selected area and a non-selected area of a self-luminous display; and reduce power consumption associated with the non-selected area; wherein the self-luminous display has a pixel addressable intensity.

The non-transitory computer readable medium may store instructions for determining of the selected area in response to a type of an application that feeds content to the self-luminous display.

The non-transitory computer readable medium may store instructions for determining the selected area in response to a position of a user in relation to the self-luminous display.

The non-transitory computer readable medium may store instructions for defining at least one additional area of the self-luminous display; and associating different power consumption levels with each one of the selected area, the non-selected area and each additional area.

The non-transitory computer readable medium may store instructions for displaying to a user multiple power saving options; receiving from the user a selected power saving option indication and wherein the reducing the power consumption associated with the non-selected area may be responsive to the selected power saving option.

The non-transitory computer readable medium may store instructions for determining the selected area in response to a location, within a three dimensional display space generated by the self-luminous display, of either one of an organ of a user and a user held object that does not contact the self-luminous display.

According to an embodiment of the invention there may be provided a mobile device that may include a self-luminous display having a pixel addressable intensity and a processor, wherein the processor may be arranged to determine a selected area and a non-selected area of a self-luminous display; and to determine a reduction of power consumption associated with the non-selected area; wherein the self-luminous display has a pixel addressable intensity.

The processor may be arranged to feed the self-luminous display with content generated by an application executed by the processor; and wherein the determining of the selected area may be responsive to a type of the application.

The processor may be arranged to determine the selected area in response to a position of a user in relation to the self-luminous display.

The processor may be arranged to define at least one additional area of the self-luminous display; and associate different power consumption levels with each one of the selected area, the non-selected area and each additional area.

The processor may be arranged to cause the self-luminous display to display to a user multiple power saving options; receive from the user a selected power saving option indication and to reduce the power consumption associated with the non-selected area in response to the selected power saving option.

The self-luminous display may be a three-dimensional display and the processor may be arranged to determine the selected area in response to a location, within a three dimensional display space generated by the self-luminous display, of either one of an organ of a user and a user held object that does not contact the self-luminous display.

### BRIEF DESCRIPTION OF DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram of a mobile device according to an embodiment of the invention;

FIG. 2 is a block diagram of a display subsystem of the mobile device according to an embodiment of the invention;

FIG. 3 is an illustration of a screen display with area of direct and immediate concern to user according to an embodiment of the invention;

FIG. 4 is an illustration of user gaze or eye tracking using front camera of mobile terminal according to an embodiment of the invention;

FIG. 5 is an illustration of touch screen operation using either direct touch or hovering finger according to an embodiment of the invention;

FIG. 6 is an illustration of touch screen operation using a stylus according to an embodiment of the invention;

FIG. 7 is a flowchart showing steps in controlling the power save of the display according to an embodiment of the invention;

FIG. 8 is an illustration of a three dimensional (3D) touch screen operation using a hovering finger according to an embodiment of the invention;

FIG. 9 is a flowchart showing steps in controlling the power save of the display according to an embodiment of the invention; and

FIG. 10 is an illustration of multiple areas of a display according to an embodiment of the invention.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

In order to save power consumed by the display of a battery driven device the individual pixels of the display are controlled such that those pixels which are not determined to be of direct or immediate concern to the user are lessened in illumination intensity compared to the area of user interest, or indeed can be turned off. Similarly, the pixel density of those areas not of user direct interest of the display may be reduced. Hence, for example, the amount that the illumination and or the pixel density is lessened in those areas outside of the user's immediate or direct concern can be varied according to several factors including the amount of charge remaining in the battery, the user's interaction with the device, the user settings, the application running on the device. The area of the display that is determined to be of direct or immediate concern to the user can be illuminated either fully or higher than the rest of the display. One or more of a combination of several methods can used to determine the area size that is of immediate and direct concern to the user. For example, this area size and the method used to determine the position of the area can be related to the application that is running on the device, the user's interaction with the device and other factors such as the distance of the user from the display or the level of the ambient luminance

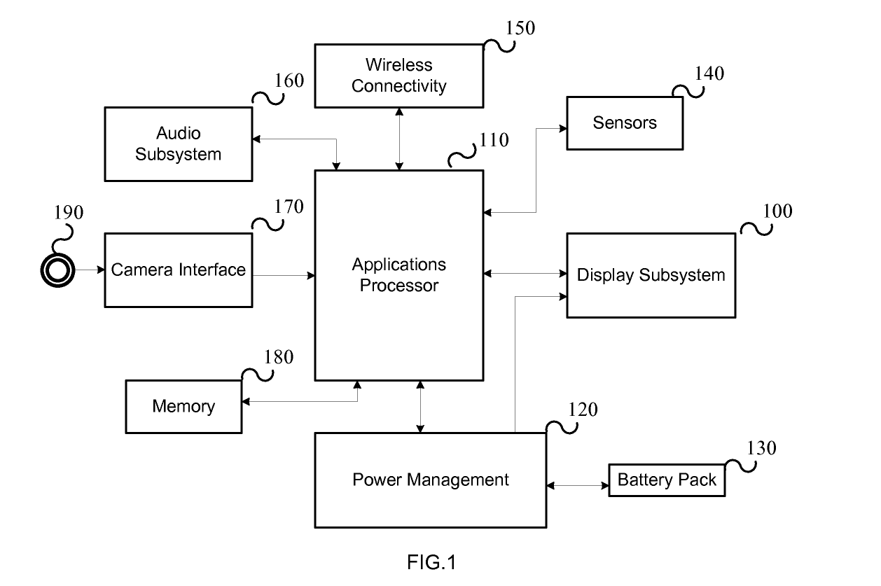

A mobile terminal device (also referred to as mobile terminal or mobile device) will be described with reference to the block schematic diagram FIG. 1. Such a device 90 may include a display subsystem 100, an applications processor 110, power management block 120, a battery pack 130, sensors 140, wireless connectivity block 150, audio subsystem 160, camera interface block 170 with camera 190, and memory 180.

The power management block 120 may include a circuitry for battery management (such as a processor) and for controlling the power supplied to various components of the mobile device.

The sensor block 140 may contain sensors for light and non-image sensors such as a specific absorption rate (SAR) proximity detector that can discriminate human body proximity.

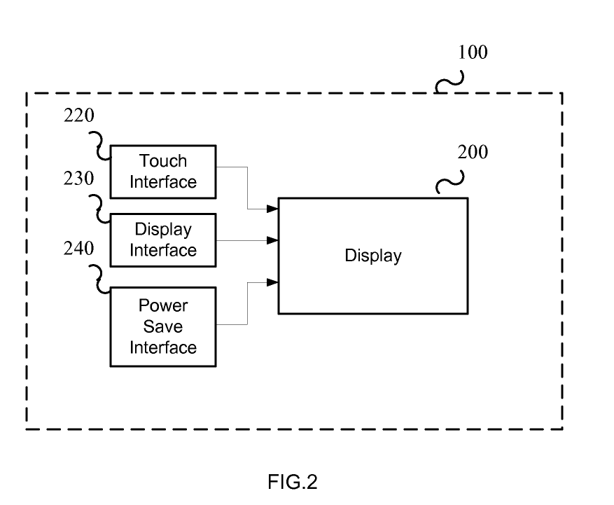

FIG. 2 is a block schematic of a display subsystem 100 which may contain a touch interface 220, a display interface 230 and a power save interface 240 according to an embodiment of the invention.

The display may be a self-luminous display with the ability to select and adjust the illumination of individual pixels such that no backlight is required and where the power consumption of such a display is variable according to the number and brightness of the illuminated pixels. An example of such a display is an Organic Light-Emitting Diode (OLED) display.

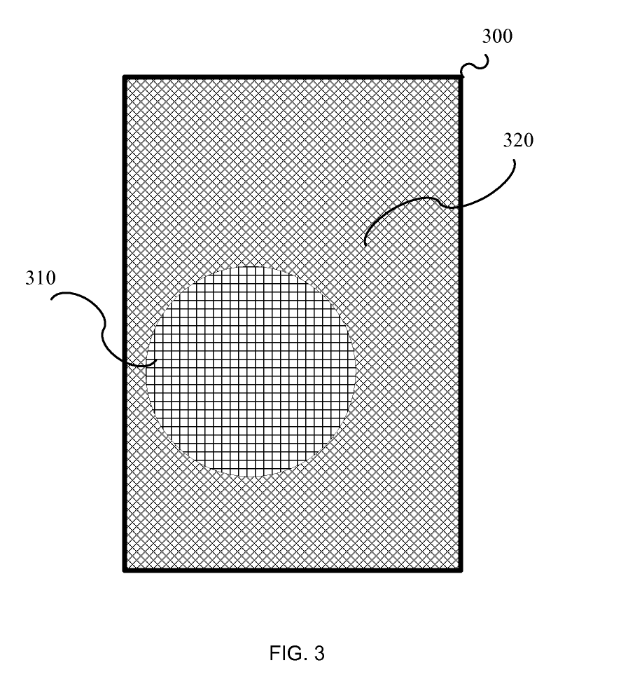

FIG. 3 illustrates the screen display 300 of a mobile terminal device as described in FIG. 1 according to an embodiment of the invention. The area 310 is the area that has been determined to be of immediate and direct interest or concern to the user of the device. This area 310 will be referred to as the ‘directed area’. Area 320 is the rest of the display area, that is to say the area that has been determined not to be of immediate and direct interest or concern to the user of the device.

This area 320 will be referred to as the ‘non-directed area’. The directed area 310 of the display can be illuminated either fully or higher than the rest of the display in the case that it has been determined that power saving is desirable or required.

In addition, the directed area 310 may be illuminated either fully or higher than the rest of the display in the case that there is high ambient luminance on the screen. In this case not only is power saved but also the ability of the user to read the screen is improved.

Similarly, the non-directed area 320 can be illuminated either fully, or at progressively lower levels of intensity than the directed area 310 in the case that it has been determined that power saving is desirable or required or the ambient luminance is high.

The pixel densities of the directed area 310 and the non-directed area 320 can also be similarly adjusted. A plurality of factors and inputs can be used in determining the area sizes and the relative difference in the illumination and pixel density and these will be discussed later.

Although the directed area 310 is shown in FIG. 3 as a circle, it should be noted that there is no restriction on the shape. For example an oval would be appropriate or even a square may be used. Some heuristic criteria may be used to determine the shape of the area with higher illumination. If text is displayed, for example, the area of interest may cover a line or a multiple of lines of text; if a picture is displayed, the area of interest may be the part of the picture with edges including the “center of gravity” of the assumed area of interest.

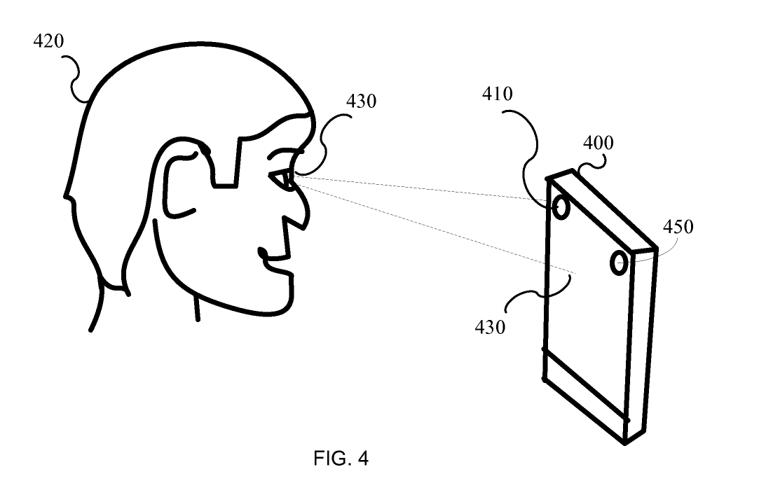

The determination of the directed area can be accomplished using a plurality of methods. FIG. 4 illustrates one such method according to an embodiment of the invention. The forward facing camera 410 of the mobile device 400 may be used to track the direction of the user's gaze. The eye 430 of the user 420 is detected by the camera 410 using eye tracking techniques, and the ‘gaze area’, which is the desired directed area 310 of the screen display, can be determined. The gaze area can be centered around point 440. The camera tracks visible ocular features of the eye, such as the pupil, and this data is used to extrapolate the rotation of the eye and ultimately the direction of the gaze. An eye tracking system may also be used to identify the gaze area. The distance of the user (user eye 430) from the display may be evaluated by analyzing the size of the user eye 430 (or other organ) in the image acquired by camera 410. Additionally or alternatively, the proximity of the user to the mobile device may be sensed by SAR proximity detector 450.

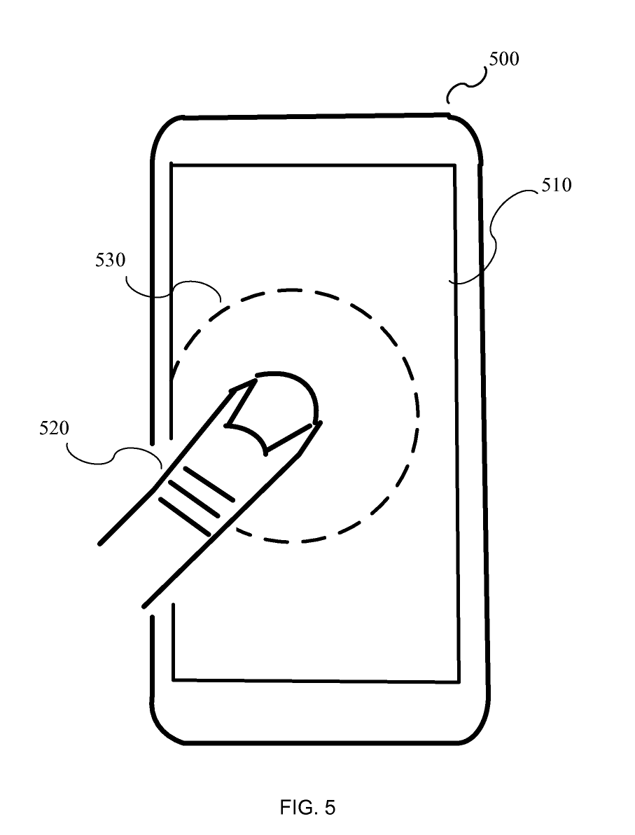

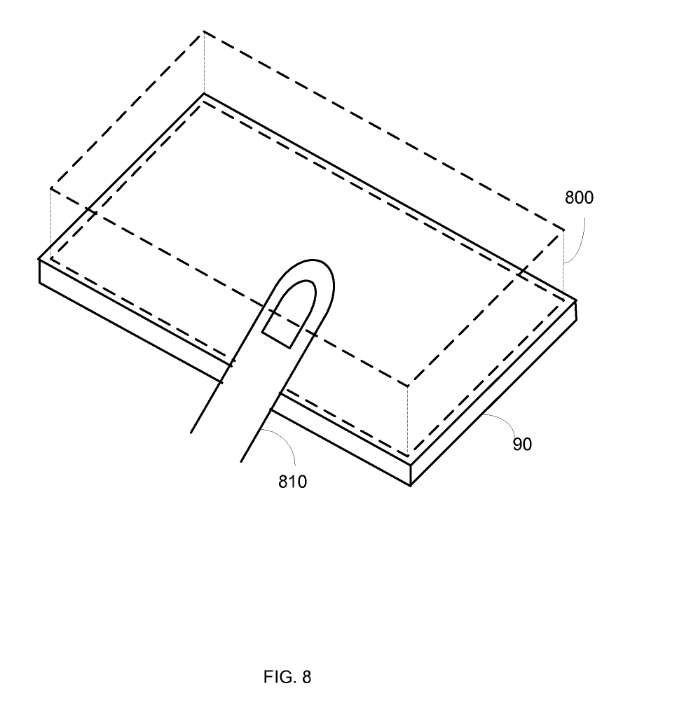

Another method for the determination of the directed area is to use the area of the screen that is being directly selected by the user. FIG. 5 illustrates a mobile device 500 with a touch screen 510. The user's finger 520 is selecting a specific point on the screen and hence a directed area 530, based upon the position of the user's finger 520, can be determined. In FIG. 5 the finger 520 may be directly touching the screen in the case of a touch screen display but it may also be hovering over the screen in the case of a 3-D touch screen display—as illustrated in FIG. 8. FIG. 8 illustrates a finger 810 that enters a three-dimensional illumination space 800 illuminated by a three dimensional display of mobile device 90. The finger 810 does not touch the display of the mobile device. The area of interest will be associated with the pixels of the display that illuminate the region that is virtually touched by the finger—for example the pixels that are responsive to illuminate an area that is located at the edge of finger 810.

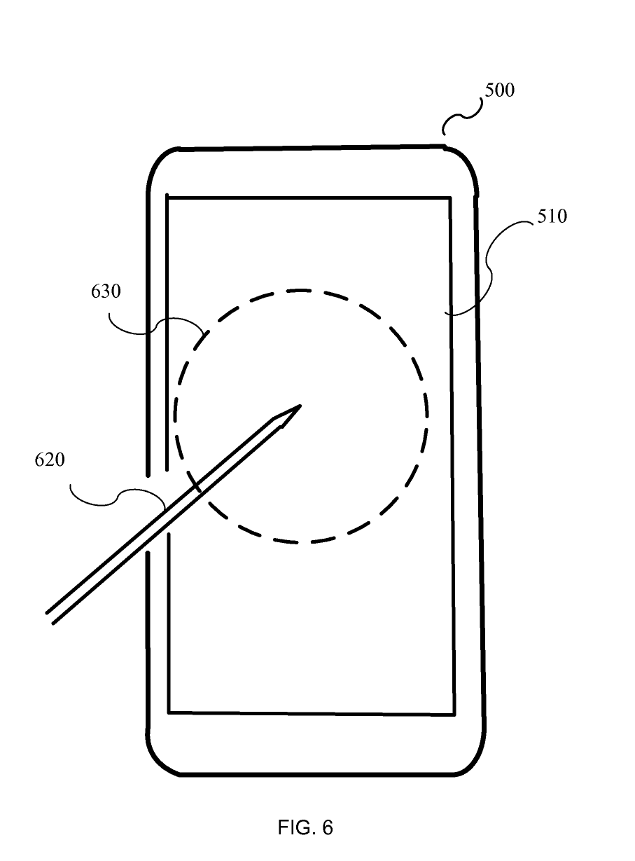

FIG. 6 illustrates a similar method to that depicted in FIG. 5 for determining the directed area. FIG. 6 illustrates a mobile device 500 with a touch screen 510. The stylus 620 is selecting a specific point on the screen and hence a directed area 630, based upon the position of the stylus 620 can be determined.

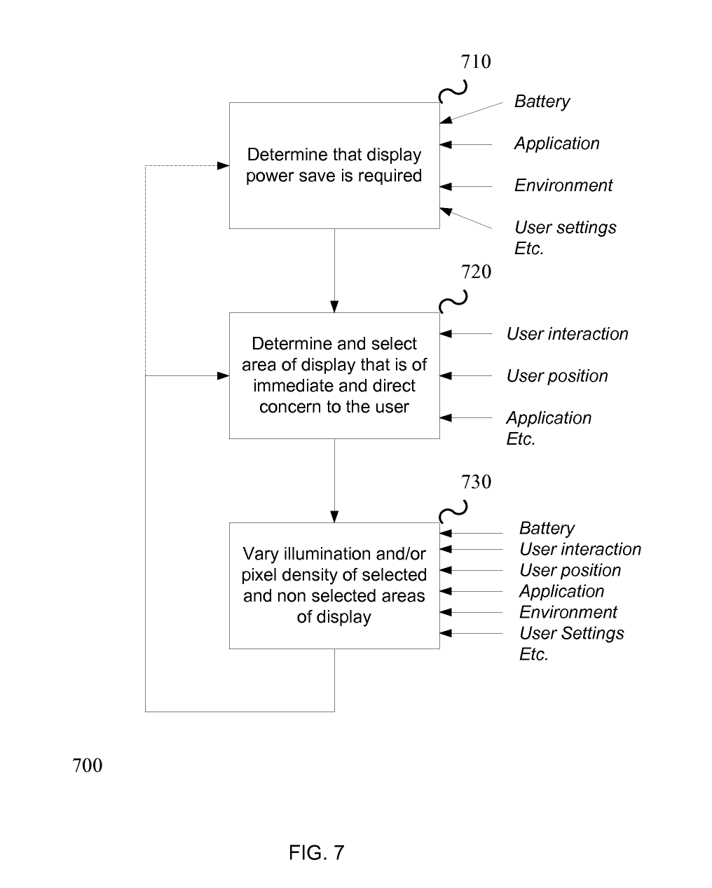

FIG. 7 is a flowchart that outlines the steps of method 710 that may be used to control the power save of the display according to an embodiment of the invention.

A plurality of factors may be used to determine if power save is desirable or required at any point in time. Step 710 determines if display based power save is required. The decision may be based on a plurality of factors including but not limited to the battery charge state, the application being run on the mobile device, the environmental conditions and the user's choice of settings. For example, display power save could be used constantly in order to preserve battery power. In this case it could be that the difference in illumination between the directed and the non-directed areas may be varied dependent upon the battery charge. It may also be decided to only use the display power save once the battery has discharged to a preset value. Certain applications could lend themselves better to display power save than others. For example, it may be decided that applications where the user is gazing upon a precise area of the screen or using the touch screen, such as texting, messaging, emailing, internet browsing, etc., could use the display power save all the time, or at least at an earlier point than, say, applications that involve video or photographs where the direction of the user's gaze is more variable. If the mobile device is being used outdoor and in high ambient light conditions, then this may also affect the decision of when to use display power save. The user may also be presented with a set of choices of when to enact the display power save.

Assuming that it has been determined to activate display power save then the determination of the selection of the directed area is the next step 720. The center of the directed area and the outer dimensions will be determined by a plurality of inputs such as the user's interaction with the mobile device, the user's position, and the application. The area of the directed area may be varied according to the detection method used, for example eye tracking or touch screen display. The position of the user may also be taken into account, for example if the user is very close to the display, as may be determined by the front mounted camera, then the area may be smaller than if the user was at a distance from the display. Of course, if the user is not looking at the screen, then the complete screen display can be off. The directed area dimensions may also be determined based upon the application that is running on the device, in a similar manner that was described previously in step 710.

Once the directed area has been determined, in step 720, then the amount of relative illumination and pixel density between the directed and non-directed areas is decided in step 730. Similar to step 720, the inputs that may be used to make the decisions might include the battery charge state, the user's interaction with the device, the position of the user relative to the device, the application being run on the device, the environment, and user settings. Based upon these inputs, the absolute and relative levels of intensity of illumination for the directed and non-directed areas of the display may be determined.

Based upon the battery condition, and also upon changes in user interaction, user position, application, environment and user settings, the decision to move between steps 720 and 730 would be made. For example, if the user interaction changed from eye gazing to touch screen, then the process would change from step 730 back to 720 and possibly back to 710 in the case of a battery re-charge.

Stage 720 may include determining a selected area and a non-selected area of the self-luminous display. The selected area was also referred to as an area of immediate and direct concern to the user of a mobile terminal device. The non-selected area may be referred to as area not of immediate or direct concern to the user.

Stage 730 may include reducing power consumption associated with the non-selected area.

As indicated by the arrow denoted “Application” directed to stage 720, stage 720 may be responsive to a type of the application being executed by the mobile device, the execution of which causes content to be fed to the display. The application type may be selected out of a text processing application and a video application. Applications of different types may differ from each other by an expected variation in a direction of a user gaze. For example—text typing applications are associated with smaller variations that video displaying applications.

As illustrated by arrows “environment” pointing to boxes 710 and 730 the reducing of the power may responsive to environmental conditions.

As illustrated by arrows “battery” pointing to boxes 710 and 730 the reducing of the power may responsive to a state of a power source that feeds the self-luminous display.

Stage 720 may be responsive to a position of a user in relation to the self-luminous display. The distance between the user and the self-luminous display may be sensed by a specific absorption rate proximity detector.

Stage 730 may include reducing of the power consumption by at least one out of reducing illumination of at least some pixels of the non-selected area and reducing pixel density of the of the non-selected area.

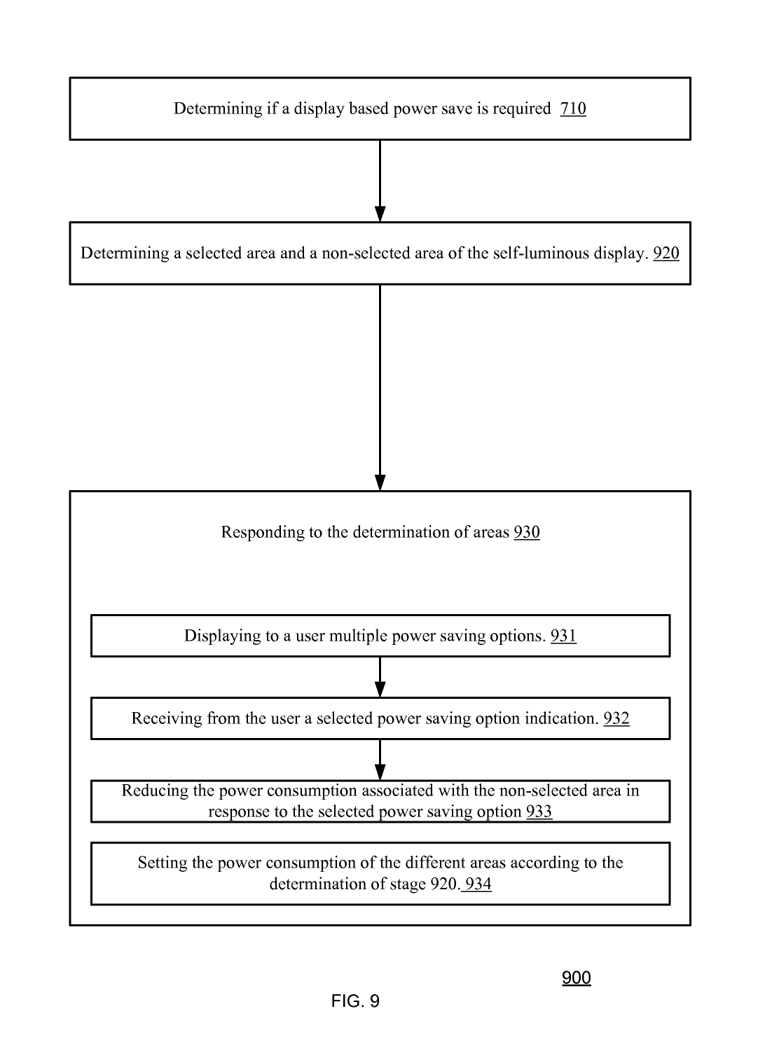

FIG. 9 illustrates method 900 according to an embodiment of the invention.

Method 900 may start by stage 710.

Stage 710 may be followed, if determining that display power save is required, by stage 920 of determining a selected area and a non-selected area of the self-luminous display.

The selected area was also referred to as an area of immediate and direct concern to the user of a mobile terminal device. The non-selected area may be referred to as area not of immediate or direct concern to the user. Any parameter mentioned in relation to stage 720 of method 700 may be applied by stage 920.

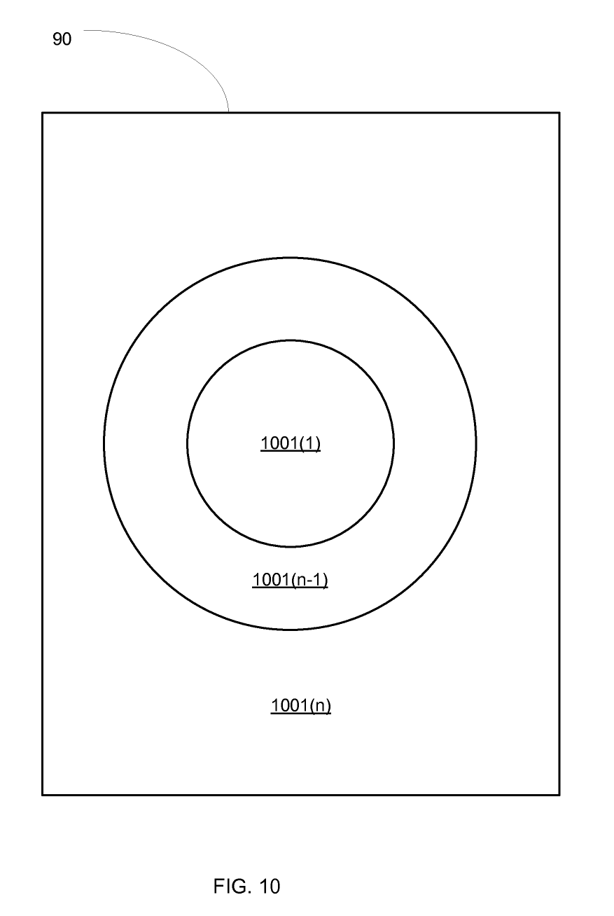

It is noted that the method is not limited to a determination of two areas—to a selected area and to a non-selected area. The determination may include determining more than three different types of areas (selected area, non-selected area and one or more additional areas), each type of area associated with a different power consumption level. FIG. 10 illustrates multiple (n) areas including a selected area 1001(1), a non-selected area 1001(n) and an additional area 1001(n-1). Index n may exceed three and there may be more than a single additional area 1001(n-1). There are n different power consumption levels that are associated with the different areas—wherein the allowable power consumption level is associated with the selected area. The different power consumptions may be enforced by changing the density of illuminated pixels, by shutting down pixels and even entire areas, by highlighting only edges of displayed shapes and the like.

A power consumption associated with an area may be a maximal power consumption level of the entire area or portion thereof, a maximal power consumption level per pixel of the area, an average power consumption level of the entire area or portion thereof, an average power consumption level per pixel of the area, or any other function of the power consumed by one or more pixels of the area.

The different areas may differ by size, shape and/or location. There may be more than a single area per area type. FIG. 10 illustrates co-centric areas—circular shaped selected area 1001(1), and an annular shaped additional area 1001(n-1). Non-selected area 1001(n) defined the remainder of the screen.

Referring back to FIG. 9—stage 920 may be followed by stage 930 of responding to the determination of areas.

Stage 930 may include stages 931-933. Stage 930 may include displaying to a user multiple power saving options. Stage 931 may be followed by stage 932 of receiving from the user a selected power saving option indication. Stage 932 may be followed by stage 933 of reducing the power consumption associated with the non-selected area in response to the selected power saving option.

Stage 930 may include stage 934 of setting the power consumption of the different areas according to the determination of stage 920. This may include reducing the power consumption of at least the non-selected area. The power consumption of the selected area may also be varied—but it is expected to be allowed to consume more power than the non-selected area.

### REFERENCE NUMERALS IN THE DRAWINGS

100 Display Subsystem of a mobile terminal device
110 Applications Processor of a mobile terminal device
120 Power Management block of a mobile terminal device
130 Battery pack of a mobile terminal device
140 Sensor block of a mobile terminal device
150 Wireless Connectivity block of a mobile terminal device
160 Audio subsystem of a mobile terminal device
170 Camera Interface block of a mobile terminal device
180 Memory block of a mobile terminal device
200 Display of a mobile terminal device
220 Touch Interface block of a mobile terminal device
230 Display interface block of a mobile terminal device
240 Display Power Save block of a mobile terminal device
300 Screen display of a mobile terminal device
310 Area of immediate and direct concern to the user of a mobile terminal device
320 Area not of immediate or direct concern to the user of a mobile terminal device
400 Mobile terminal device
410 Front mounted camera of a mobile terminal device
420 User of a mobile terminal device
430 Eye of user of a mobile terminal device
440 Direction of gaze of user of a mobile terminal device
450 SAR detector
500 Mobile terminal device
510 Screen display of a mobile terminal device
520 Finger of user of a mobile terminal device
530 Area of immediate and direct concern to the user of a mobile terminal device based upon finger position
620 Stylus of user of a mobile terminal device
620 Area of immediate and direct concern to the user of a mobile terminal device based upon stylus position
700 Method.
710, 720, 730 stages of method 700.
800 Area illuminated by 3D display.
810 Finger.
900 Method.
920, 930 stages of method 900.
931-934 states of stage 930 of method 900.
1001(1)-1001(n) areas of different interest levels.

While the above descriptions contain many specifics, these should not be construed as limitations on the scope, but rather as an exemplification of one or several embodiments thereof. Many other variations are possible. For examples, the exact method used to calculate the average received signal strength may vary, the actual signals used to determine the received signal strength can be various, the steps used to determine if a beacon has been missed in the case that beacons are used to calculate the received signal strength or to account for a missed beacon can be various, the values for the received signal strength upper limit and margin may not need to be preset but may variable and be determined by network conditions, similarly other preset values as shown in step 400 of FIG. 9 may be variable and determined by network conditions rather than preset, the details of the steps as described in FIG. 9 may be further separated or combined. Accordingly, the scope should be determined not by the embodiments illustrated, but by the appended claims and their legal equivalents.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method for power management of a self-luminous display having a pixel addressable intensity, the method is executed by a device that comprises the self-luminous display and comprises:
determining a selected area and a non-selected area of the self-luminous display; and
reducing power consumption associated with the non-selected area.

2. The method according to claim 1 wherein the self-luminous display is fed by content generated by an application; wherein the determining of the selected area is responsive to a type of the application.

3. The method according to claim 2 wherein the application is selected out of a text processing application and a video application.

4. The method according to claim 2 wherein applications of different types differ from each other by an expected variation in a direction of a user gaze.

5. The method according to claim 2 wherein the reducing of the power is responsive to environmental conditions.

6. The method according to claim 2 wherein the reducing of the power is responsive to a state of a power source that feeds the self-luminous display.

7. The method according to claim 1 wherein the determining of the selected area is responsive to a position of a user in relation to the self-luminous display.

8. The method according to claim 7 comprising sensing a distance between the user and the self-luminous display by a specific absorption rate proximity detector.

9. The method according to claim 1 wherein the reducing of the power consumption comprises at least one out of reducing illumination of at least some pixels of the non-selected area and reducing pixel density of the of the non-selected area.

10. The method according to claim 1 comprising defining at least one additional area of the self-luminous display; and associating different power consumption levels with each one of the selected area, the non-selected area and each additional area.

11. The method according to claim 1 comprising displaying to a user multiple power saving options; receiving from the user a selected power saving option indication and reducing the power consumption associated with the non-selected area in response to the selected power saving option.

12. The method according to claim 11 wherein the determining of selected area and of non-selected area of the self-luminous display is responsive to a location point of contact between the self-luminous display and at least one of a user and a user held object.

13. The method according to claim 11 comprising defining at least one additional area of the self-luminous display; and associating different power consumption levels with each one of the selected area, the non-selected area and each additional area.

14. The method according to claim 1 wherein the self-luminous display is a three-dimensional display and wherein determining of the selected area is responsive to a location, within a three dimensional display space generated by the self-luminous display, of either one of an organ of a user and a user held object that does not contact the self-luminous display.

15. A non-transitory computer readable medium that stores instructions that once executed by a computer cause the computer to determine a selected area and a non-selected area of a self-luminous display; and reduce power consumption associated with the non-selected area; wherein the self-luminous display has a pixel addressable intensity.

16. The non-transitory computer readable medium according to claim 15 that stores instructions for determining of the selected area in response to a type of an application that feeds content to the self-luminous display.

17. The non-transitory computer readable medium according to claim 15 that stores instructions for determining the selected area in response to a position of a user in relation to the self-luminous display.

18. The non-transitory computer readable medium according to claim 15 that stores instructions for defining at least one additional area of the self-luminous display; and associating different power consumption levels with each one of the selected area, the non-selected area and each additional area.

19. The non-transitory computer readable medium according to claim 15 that stores instructions for displaying to a user multiple power saving options; receiving from the user a selected power saving option indication and wherein the reducing the power consumption associated with the non-selected area is responsive to the selected power saving option.

20. The non-transitory computer readable medium according to claim 15 that stores instructions for determining the selected area in response to a location, within a three dimensional display space generated by the self-luminous display, of either one of an organ of a user and a user held object that does not contact the self-luminous display.

21. A mobile device that comprises a self-luminous display having a pixel addressable intensity and a processor, wherein the processor is arranged to determine a selected area and a non-selected area of a self-luminous display; and to determine a reduction of power consumption associated with the non-selected area; wherein the self-luminous display has a pixel addressable intensity.

22. The mobile device according to claim 21 wherein the processor is arranged to feed the self-luminous display with content generated by an application executed by the processor; and
wherein the determining of the selected area is responsive to a type of the application.

23. The mobile device according to claim 21 wherein the processor is arranged to determine the selected area in response to a position of a user in relation to the self-luminous display.

24. The mobile device according to claim 21 wherein the processor is arranged to define at least one additional area of the self-luminous display; and associate different power consumption levels with each one of the selected area, the non-selected area and each additional area.

25. The mobile device according to claim 21 wherein the processor is arranged to cause the self-luminous display to display to a user multiple power saving options; receive from the user a selected power saving option indication and to reduce the power consumption associated with the non-selected area in response to the selected power saving option.

26. The mobile device according to claim 21 wherein the self-luminous display is a three-dimensional display and wherein the processor is arranged to determine the selected area in response to a location, within a three dimensional display space generated by the self-luminous display, of either one of an organ of a user and a user held object that does not contact the self-luminous display.
